(19) United States
(12) Patent Application Publication
(10) Pub. No.: US 2006/0085810 A1
(43) Pub. Date: Apr. 20, 2006

(54) OPTICAL DISC DRIVE AND OPTICAL DISC CASSETTE

(76) Inventor: Jui-Chiang Lin, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,353

(22) Filed: Oct. 17, 2005

(30) Foreign Application Priority Data
Oct. 20, 2004 (TW) 93131759

(51) Int. Cl. G11B 23/03

(52) U.S. Cl. 720/737

(57) ABSTRACT

An optical disc drive and an optical disc cassette are provided. The optical disc cassette of the optical disc drive comprises a housing, a plurality of optical disc carriers and an anti-rotation element. The optical disc carrier is suitable for putting inside the housing. Each optical disc carrier has an indentation located on its edge. The anti-rotation element is disposed inside the housing to correspond with the indentation. The anti-rotation element can be a multi-section type or a sweeping type of component for being against the edges of optical discs having various sizes when the optical disc carriers are put into the housing.

### CROSS-REFERENCE TO RELATED APPLICATION

This application claims the priority benefit of Taiwan application serial no. 93131759, filed on Oct. 20, 2004. All disclosure of the Taiwan application is incorporated herein by reference.

### BACKGROUND OF THE INVENTION

1. Field of the Invention

The present invention relates to a storage medium drive and a storage medium cassette. More particularly, the present invention relates to an optical disc drive and an optical disc cassette.

2. Description of the Related Art

Because of the many advantages of optical storage discs including large data storage capacity, long service life and low production cost, they are gradually replacing the conventional magnetic storage medium to become one of the indispensable optical storage media. Since a conventional optical disc drive can store at most one optical disc at a time, a user requiring to read the data in another disc needs to change the disc manually. Due to our desire for accessing a number of discs rapidly without manual intervention, optical disc drives capable of holding a number of optical discs at a time have been developed. Thus, users can read from a particular optical disc whenever they want without the need to stop and spend time changing the disc manually.

An optical disc drive capable of storing a plurality of optical discs at the same time comprises a host and an optical disc cassette. After loading a plurality of optical discs into the optical disc cassette, the optical disc cassette can be inserted into the host machine so that the host machine can perform the necessary data accessing operation. However, this type of optical disc cassette is designed to accommodate optical discs with a diameter of 12 cm only. No provision is provided in the optical disc cassette to accept an 8-cm-diameter optical disc. Therefore, users may found this type of optical disc drive puzzling and inconvenient.

### SUMMARY OF THE INVENTION

Accordingly, at least one objective of the present invention is to provide an optical disc drive having an optical disc cassette suitable for storing optical discs of various sizes.

At least a second objective of the present invention is to provide an optical disc cassette suitable for storing optical discs of various sizes.

To achieve these and other advantages and in accordance with the purpose of the invention, as embodied and broadly described herein, the invention provides an optical disc cassette suitable for storing a plurality of optical discs. The optical disc cassette mainly comprises a housing, a plurality of optical disc carriers and a sweeping anti-rotation element. The optical disc carriers are suitable for positioning inside the housing. Each optical disc carrier has a carrier surface and an indentation located at its edge. The sweeping anti-rotation element is a movable set up disposed inside the housing to correspond with the indentation. The sweeping anti-rotation element is capable of moving inside the indentation to be against the edges of the optical discs when the optical disc carrier is loaded into the housing.

The present invention also provides an optical disc drive having a disc exchanger, a data processing module and an optical disc cassette. The disc exchanger is suitable for operating within an operating range and the data processing module is disposed within the operating range of the disc exchanger. The optical disc cassette is also disposed within the operating range of the disc exchanger and is suitable for storing a plurality of optical discs. Here, the optical disc cassette of the optical disc drive is the aforementioned optical disc cassette with a sweeping type anti-rotation element therein.

In the optical disc cassette and optical disc drive, the sweeping anti-rotation element comprises a straight rod or a plurality of separately movable anti-rotation units each capable of moving inside an indentation.

The present invention also provides an alternative optical disc cassette suitable for storing at least a first optical disc and at least a second optical disc having a size different from the first optical disc. The optical disc cassette mainly comprises a housing, a plurality of optical disc carriers and a multi-section anti-rotation element. The optical disc carriers are disposed inside the housing. Each optical disc carrier has a carrier surface and an indentation on its edge. The multi-section anti-rotation element is disposed inside the housing to correspond with the indentation. The multi-section anti-rotation element is suitable for being against the edges of the first optical disc and the second optical disc when the optical disc carriers are inserted into the housing.

The present invention also provides an alternative optical disc drive. The optical disc drive mainly comprises a disc exchanger, a data processing module and an optical disc cassette. The disc exchanger is suitable for operating within an operating range and the data processing module is disposed within the operating range of the disc exchanger. The optical disc cassette is also disposed within the operating range of the disc exchanger and is suitable for storing at least a first optical disc and at least a second optical having a size different from the first optical disc. Here, the optical disc cassette of the optical disc drive is the aforementioned optical disc cassette with a multi-section type anti-rotation element therein.

In the aforementioned optical disc cassette and optical disc drive, the multi-section anti-rotation element comprises at least a first portion and at least a second portion. The first portion is suitable for being against the edge of the first optical disc and the second portion is suitable for being against the edge of the second optical disc. Furthermore, the first portion and the second portion can be connected together or detached from each other.

In the two aforementioned types of optical disc drive, the data processing module is an optical disc pick-up module or an optical disc read/write module, for example.

In the two aforementioned types of optical disc cassettes and optical disc drives, each carrier surface further comprises a first optical disc carrier region and a second optical disc carrier region. Furthermore, at least part of the indentations extends from the edge of the optical disc carrier to the edge of the first optical disc carrier region. In addition, each optical disc carrier has a plurality of anti-slip structures disposed on the edge of the first optical carrier region. The anti-slip structure is suitable for positioning the optical disc within the first optical disc carrier region. Moreover, the optical disc cassette further comprises a latching element disposed on the inner wall of the housing. Each optical disc carrier has a latching portion suitable for latching with the latching element. Additionally, the housing has an opening and a plurality of guiding tracks. The guiding tracks are set up on the inner wall of the housing. The guiding tracks extend in a direction towards the opening. Each optical disc carrier is suited to slide on one of the guiding tracks.

In brief, due to the setup of the indentation and the anti-rotation element on the optical disc carriers inside the optical disc drive and the optical disc cassette of the present invention, optical discs of various sizes can be conveniently stored to facilitate the user.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of an optical disc drive according to one preferred embodiment of the present invention.

FIG. 2 is a perspective view showing the external appearance of an optical disc cassette according to one embodiment of the present invention.

FIG. 3 is a cutaway view showing the interior of an optical disc cassette according to one embodiment of the present invention.

FIGS. 4A and 4B are sketches showing the position of the anti-rotation element when two optical discs having different sizes are placed within the optical disc carrier of an optical disc cassette according to one embodiment of the present invention.

FIGS. 5A and 5B are schematic cross-sectional views showing the contact portion between the anti-rotation element and the optical disc carrier for the optical disc cassettes shown in FIGS. 4A and 4B.

FIG. 6 is a schematic cross-sectional view along line I-I of the optical disc carrier in FIG. 4A.

FIG. 7 is a schematic cross-sectional view showing an optical disc cassette having another type of sweeping anti-rotation element installed therein.

FIGS. 8A and 8B are schematic cross-sectional views showing the contact portion between the anti-rotation element and the optical disc carrier within another two types of optical disc cassettes.

FIGS. 9 and 10 are schematic cross-sectional views showing the contact portion between the anti-rotation element and the optical disc carrier within yet another two types of optical disc cassettes.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

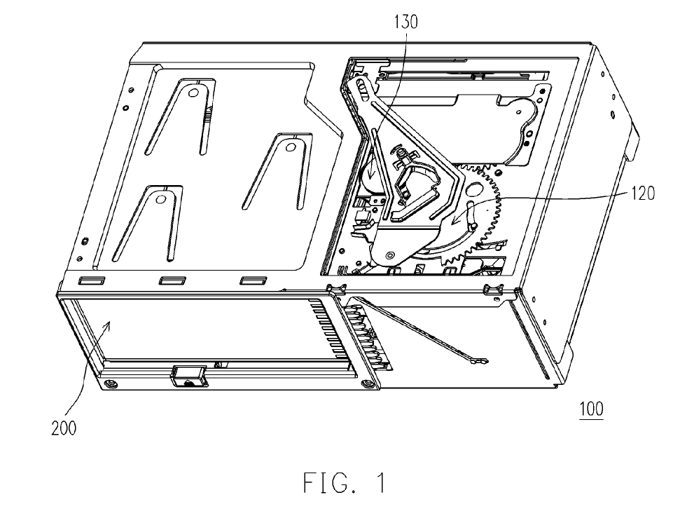

FIG. 1 is a perspective view of an optical disc drive according to one preferred embodiment of the present invention. As shown in FIG. 1, the optical disc drive 100 is a compact disc player (a CD player), a laser optical video disc player (a LD player), a video compact disc player (a VCD player), a digital video disc player (a DVD player) or other optical disc players capable of storing a multiple of optical discs at the same time, for example.

The optical disc drive 100 mainly comprises a disc exchanger 120, a data processing module 130 and an optical disc cassette 200. The disc exchanger 120 is suitable for operating within an operating range and the data processing module 130 is also disposed within the operating range of the disc exchanger 120 for storing a plurality of optical discs (not shown). The disc exchanger 120 is mainly used for transporting an optical disc from the optical disc cassette 200 to the data processing module 130 or returning an optical disc from the data processing module 130 to the optical disc cassette 200. The disc exchanger 120 may comprise a set of linked levers and gears or other suitable mechanical design, for example. However, the actual operating mechanism of the disc exchanger 120 is not limited to the one shown in FIG. 1. The data processing module 130 is, for example, an optical pick-up module for reading stored data inside the optical disc. Obviously, the data processing module 130 can also be an optical disc reading/writing module that allows data to be written to the optical disc. A detailed description of the optical disc drive 100 and its optical disc cassette 200 is given below.

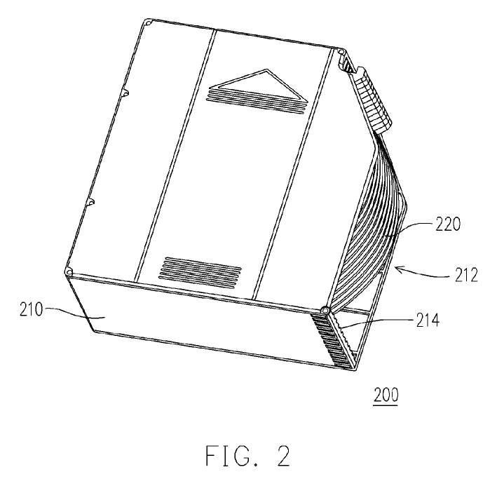

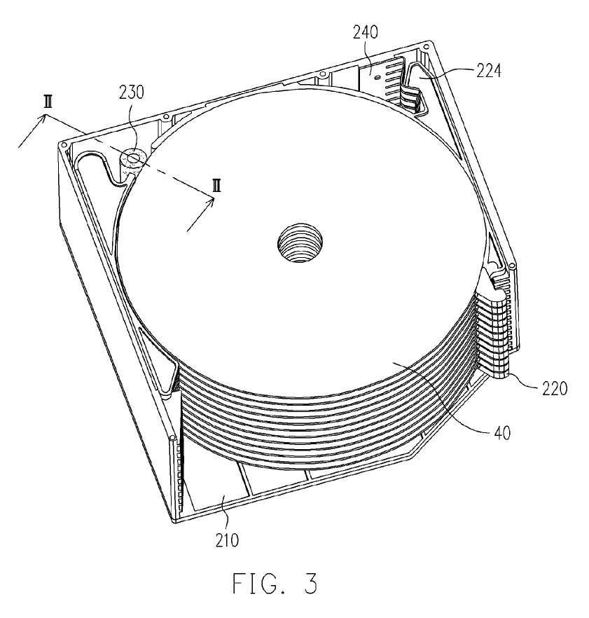

FIG. 2 is a perspective view showing the external appearance of an optical disc cassette according to one embodiment of the present invention. FIG. 3 is a cutaway view showing the interior of an optical disc cassette according to one embodiment of the present invention. As shown in FIGS. 2 and 3, the optical disc cassette 200 mainly comprises a housing 210, a plurality of optical disc carriers 220 and a sweeping anti-rotation element 230. The housing 210 may have an opening 212 and a plurality of sets of guiding tracks 214. The guiding tracks 214 are disposed on an inner wall of the housing 210. Furthermore, the guiding tracks 214 extend in a direction towards the opening 212. Each optical disc carrier 220 is suitable for carrying an optical disc 40 and sliding along a set of guiding tracks 214 into the housing 210. Because the optical disc cassette 200 can store a plurality of optical discs at a time, a user is free to select the desired optical disc and perform the reading without changing discs manually. This saves a lot of time and adds to the convenience of operation.

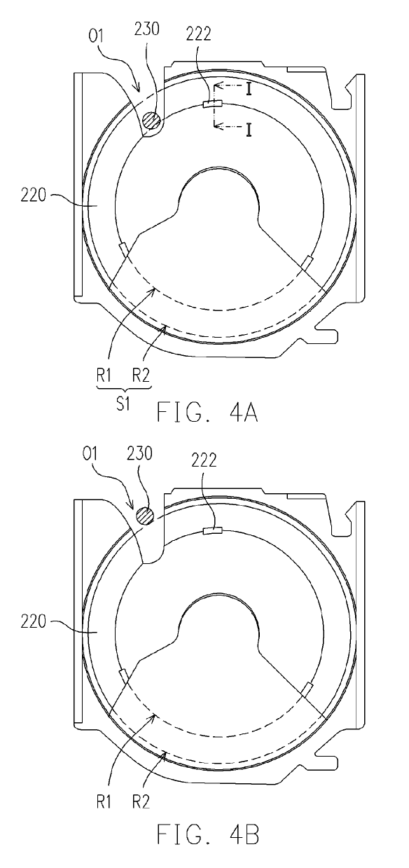

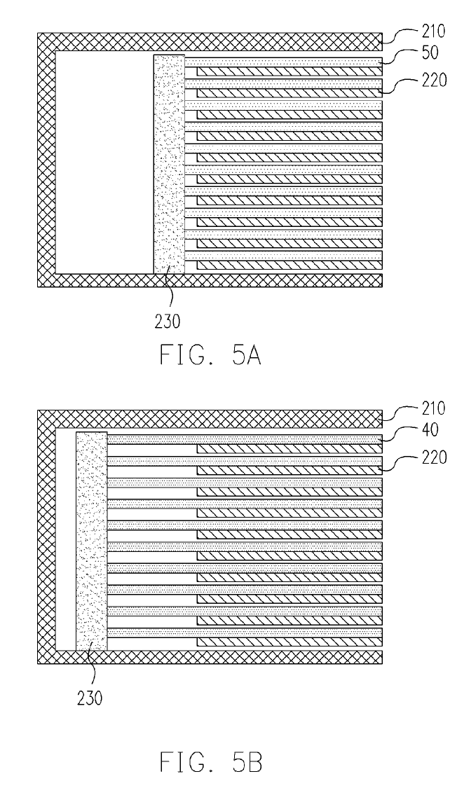

FIGS. 4A and 4B are sketches showing the position of the anti-rotation element when two optical discs having different sizes are placed within the optical disc carrier of an optical disc cassette according to one embodiment of the present invention. FIGS. 5A and 5B are schematic cross-sectional views showing the contact portion between the anti-rotation element and the optical disc carrier for the optical disc cassettes shown in FIGS. 4A and 4B. In the present embodiment, the sweeping anti-rotation element 230 is a straight rod, for example.

As shown in FIG. 4A, each optical disc carrier 220 has a carrier surface S1. The carrier surface S1 comprises a first optical disc carrier region R1 and a second optical disc carrier region R2, for example. The first optical disc carrier region R1 and the second optical disc carrier region R2 have a circular shape, for example. More definitely, the first optical disc carrier region R1 has a shape that corresponds with an optical disc having an 8 cm diameter and the second optical disc carrier region R2 has a shape that corresponds with an optical disc having a 12 cm diameter, for example. Furthermore, the first optical disc carrier region R1 and the second optical disc carrier region R2 may have a common center point. Each optical disc carrier 220 further has an indentation O1 that extends from the edge of the optical disc carrier 220 to the edge of the first optical disc carrier region R1. In addition, each optical disc carrier 220 has a plurality of anti-slip structures 222 disposed on the edge of the first optical disc carrier region R1. Here, there are three anti-slip structures 222. The anti-slip structures 222 positions an 8-cm diameter optical disc (not shown) within the first optical disc carrier region R1, for example.

As shown in FIG. 3, the sweeping anti-rotation element 230 is a movable component disposed inside the housing 210 to correspond with the indentation O1 in the optical disc carrier 220. As shown in FIGS. 4A and 5, when the optical disc carrier 220 is inserted into the housing 210, if the size of the optical disc 50 carried by the optical disc carrier 220 corresponds to the first optical disc carrier region R1, then the sweeping anti-rotation element 230 will lie beside the edge of the first optical disc carrier region R1 within the indentation O1 to be against the edge of the optical disc 50 placed inside the first optical disc carrier region R1 and prevent any rotation of the optical disc 50.

As shown in FIGS. 4B and 5B, when the optical disc carrier 220 is inserted into the housing 210, if the size of the optical disc 40 carried by the optical disc carrier 220 corresponds to the second optical disc carrier region R2, then the sweeping anti-rotation element 230 will move towards the edge of the second optical disc carrier region R2 within the indentation O1 to be against the edge of the optical disc 40 placed inside the second optical disc carrier region R2 and prevent the optical disc 40 from rotation.

In the absence of any external force on the sweeping anti-rotation element 230, the sweeping anti-rotation element 230 stations at the edge of the first optical disc carrier region R1 within the indentation O1, for example. When the sweeping anti-rotation element 230 is subjected to an external force (for example, a push from a larger size optical disc 40), it will move to the edge of the second optical disc carrier region R2 within the indentation O1. As soon as the external force disappears (for example, removing the large size optical disc 40), the sweeping anti-rotation element 230 will return to the edge of the first optical disc carrier region R1 by means of a spring or an elastic device, for example.

In the aforementioned description, due to the presence of the indentation O1 in the optical disc carrier, the sweeping anti-rotation element 230 is free to move inside the indentation O1. Therefore, it does not matter what the size of the optical disc carried by the optical disc carrier 220 is (for example, an optical disc having an 8 or 12 cm diameter), the sweeping anti-rotation element 230 can still press against the edge of the optical disc to suppress rotation. Hence, all types of optical disc can be inserted into the optical disc drive 100 and the optical disc cassette 200 of the present embodiment.

Although the indentation O1 shown in FIG. 4A extends to the edge of the first optical disc carrier region R1, part of the indentations O1 may extend to the edge of the second optical disc carrier region R2 only.

FIG. 6 is a schematic cross-sectional view along line I-I of the optical disc carrier in FIG. 4A. As shown in FIG. 6, the anti-slip structure 222 in the optical disc carrier 220 is an inverted L-shaped structure capable of positioning an optical disc 50 inside the first optical disc carrier region R1. Obviously, the anti-slip structure 222 can have other structural design. One major design criterion is the capacity to station the optical disc 50 within the first optical disc carrier region R1.

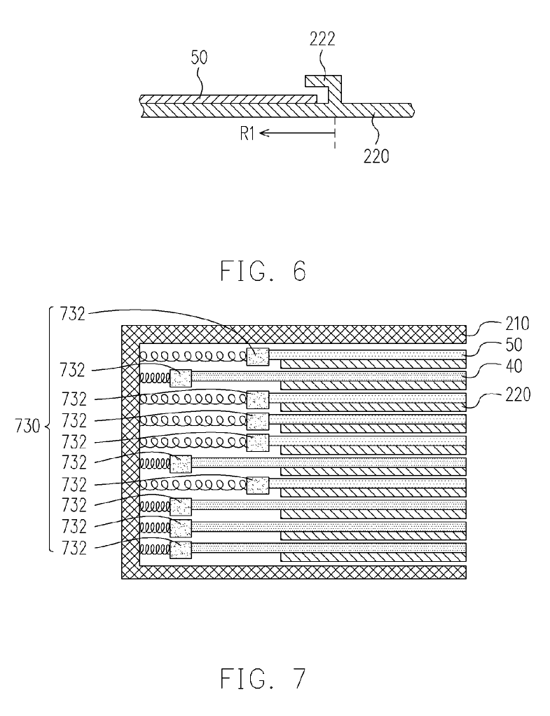

FIG. 7 is a schematic cross-sectional view showing an optical disc cassette having another type of sweeping anti-rotation element installed therein. As shown in FIG. 7, the location of the sectioning is similar to the one in FIG. 5A. In the present embodiment, the sweeping anti-rotation element 730 comprises a plurality of anti-rotation units 732. Each anti-rotation unit 732 corresponds with the indentation O1 of an optical disc carrier 220. With this type of design, the anti-rotation unit 732 can suitably be against the edge of the optical disc no matter if a large optical disc 40 or a small optical disc 50 are disposed inside the optical disc carriers 220. Although springs are shown linking the anti-rotation unit 732 and the housing 210 in FIG. 7, other types of suitable design can also be used.

As shown in FIG. 3, to park the optical disc carrier 220 inside the housing 210 in a secure way, the optical disc cassette of the present embodiment further includes a latching element 240 disposed on an inner wall of the housing 210 and facing the opening 212, for example. Furthermore, each optical disc carrier 220 also has a corresponding latch-up portion 224. The latch-up portion 224 of the optical disc carrier 220 is suitable for engaging with the latching element 240. The latching element 240 is a spring, for example.

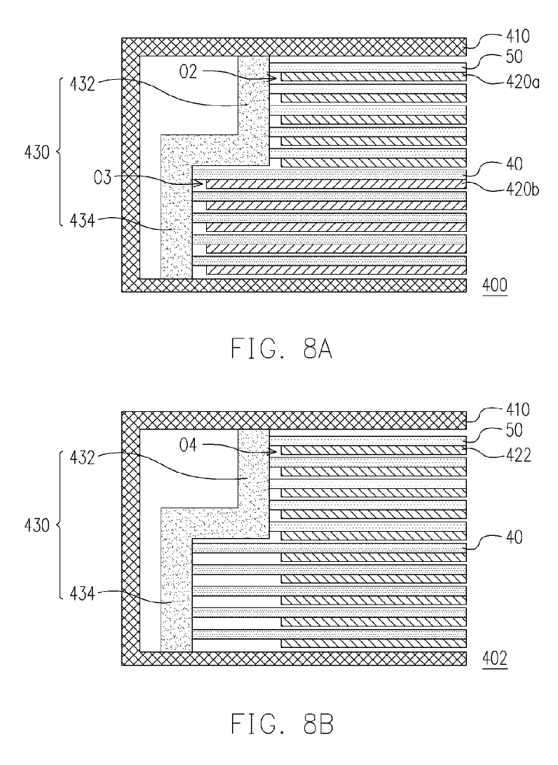

In the following, another embodiment of the optical disc cassette is described. One major difference between the present embodiment and the previous embodiment is in the design of the anti-rotation element. Since the other portions are identical, descriptions of them are omitted. FIGS. 8A and 8B are schematic cross-sectional views showing the contact portion between the anti-rotation element and the optical disc carrier within another two types of optical disc cassettes.

FIG. 8A is a section along II-II in the direction that vertical to Y-axis. In the present embodiment, the optical disc cassette 400 is suitable for storing at least an optical disc 50 and at least a second optical disc 40 having a different dimension from the first optical disc 50. The optical disc cassette mainly comprises a housing 410, at least an optical disc carrier 420a (in this example, there are five of them), at least an optical disc carrier 420b (in this example, there are five of them) and a multi-section anti-rotation element 430. Similar to the previous embodiment, the optical disc carrier 420a has an indentation O2 and the optical disc carrier 420b has an indentation O3. Here, the indention O2 is larger than the indentation O3. The optical disc carrier 420a is suitable for carrying an optical disc 50 while the optical disc carrier 420b is suitable for carrying an optical disc 40.

The multi-section anti-rotation element 430 is disposed inside the housing 410 to correspond with the indentation O2 and the indentation O3. The multi-section anti-rotation element 430 comprises a first portion 432 and a second portion 434. The first portion 432 corresponds with a portion of the optical disc carrier 420a and the second portion 434 corresponds with a portion of the optical disc carrier 420b. The portion of the multi-section anti-rotation element 430 for contacting with the optical disc 40 and 50 is fabricated using a material such as foamy sponge, rubber or other material. Thus, when the optical disc carrier 420a and the optical disc carrier 420b are inserted into the housing 210, the first portion 432 is located within the indentation O2 to be against the edge of the optical disc 50 and the second portion 434 is located within the indentation O3 to be against the edge of the optical disc 40. Through this design, the optical disc cassette 400 of the present embodiment can store optical discs 40 and 50 each having a different dimension at the same time. Obviously, the optical disc cassette 400 can replace the optical disc cassette 200 in FIG. 1 when it is applied to the optical disc drive 100.

As shown in FIG. 8B, the optical disc cassette 402 in the present embodiment differs from the previous embodiment in that the two types of optical disc carriers 420a and 420b are integrated together to produce an optical disc carrier 422 having the characteristics of both the optical disc carrier 420a and the optical disc carrier 420b. More definitely, the optical disc carrier 422 is identical to the optical disc carrier 220 in FIG. 4A and the optical disc carrier 402 still has all the advantages of the optical disc cassette 400 in FIG. 8A. In the meantime, by integrating the two types of optical disc carriers together to form the optical disc carrier 422, the production cost of the optical disc cassette 402 is reduced.

Although the optical disc cassette 400 and the optical disc cassette 402 in FIGS. 8A and 8B has a multi-section anti-rotation element 430 with the first portion 432 capable of holding five optical disc 50 and the second portion 434 capable of holding five optical discs 40, the number of different optical discs that can be accommodated by the first portion 432 and the second portion 434 can be adjusted according to the actual requirements.

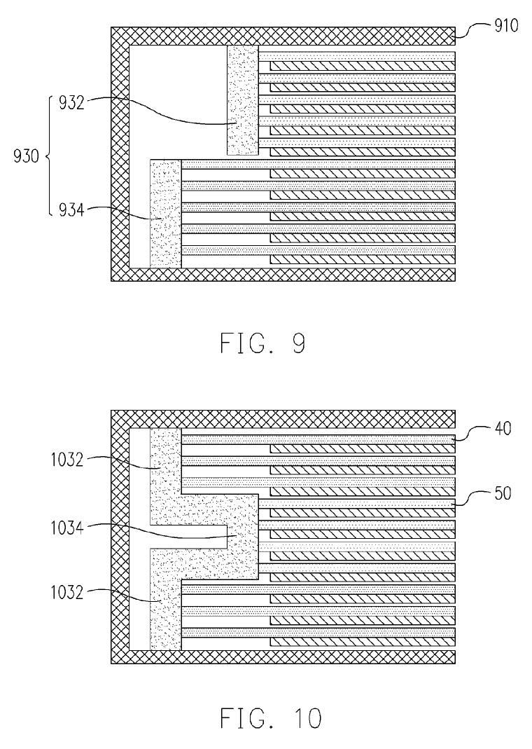

FIGS. 9 and 10 are schematic cross-sectional views showing the contact portion between the anti-rotation element and the optical disc carrier within yet another two types of optical disc cassettes. As shown in FIG. 9, the multi-section anti-rotation element 930 comprises two detached portions, a first portion 932 and a second portion 934. The first portion 932 and the second portion 934 are separately fastened to the upper and the lower side of the housing 910. As shown in FIG. 10, the multi-section anti-rotation element 1030 also could comprise two first portions 1032 and a second portion 1034. In the two aforementioned embodiments, the first portion 932, 1032 is suitable for being against the edge of the optical disc 40 while the second portion 934, 1034 are suitable for being against the edge of the optical disc 50.

It should be noted that anti-rotation element inside the optical disc drive and the optical disc cassette of the present invention is not limited to the sweeping type or the multi-section type. Other design for the anti-rotation element is possible as long as the design is capable of being against the optical disc of various dimensions within the indentation of the optical disc carrier.

In summary, each of the optical disc carriers of the optical disc drive and the optical disc cassette of the present invention have an indentation design together with a sweeping anti-rotation element or a multi-section anti-rotation element. Hence, optical disc of whatever size including the 8-cm and the 12-cm diameter optical disc can be positioned inside the optical disc cassette and prevented from rotation by being against the anti-rotation element. Ultimately, the optical disc drive and the optical disc cassette are more convenient to use.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical disc cassette suitable for storing a plurality of optical discs, comprising:
a housing;
a plurality of optical disc carriers suitable of inserting inside the housing, wherein each optical disc carrier has a carrier surface and an indentation located on an edge; and
a sweeping anti-rotation element disposed in a movable way inside the housing to correspond with the indentation, wherein the sweeping anti-rotation element is suitable for moving inside the indentation to be against the edges of the optical discs when the optical disc carrier is inserted into the housing.

2. The optical disc cassette of claim 1, wherein the sweeping anti-rotation element comprises a straight rod or a plurality of separately movable anti-rotation units inside the indentation.

3. The optical disc cassette of claim 1, wherein each carrier surface has a first optical disc carrier region and a second optical disc carrier region and at least part of the indentations extends from the edge of the optical disc carrier to the edge of the first optical disc carrier region.

4. The optical disc cassette of claim 3, wherein each optical disc carrier has a plurality of anti-slip structures disposed on the edge of the first optical disc carrier region and the anti-slip structures are suitable for positioning the optical disc inside the first optical disc carrier region.

5. The optical disc cassette of claim 1, further comprises a latching element disposed on an inner wall of the housing wherein each optical disc carrier has a latch-up portion for engaging with the latching element.

6. The optical disc cassette of claim 1, wherein the housing has an opening and a plurality of sets of guiding tracks disposed on the inner wall of the housing such that each guiding track extends in a direction towards the opening and each optical disc carrier is suitable for sliding within a set of the guiding tracks.

7. An optical disc cassette suitable for storing at least a first optical disc and at least a second optical disc having a dimension different from the first optical disc, comprising:
a housing;
a plurality of optical disc carriers suitable for inserting inside the housing, wherein each optical disc carrier has a carrier surface and an indentation located on an edge; and
a multi-section anti-rotation element disposed inside the housing to correspond with the indentation, wherein the multi-section anti-rotation element is suitable for being against the edges of the first optical disc and the second optical disc when the optical disc carriers are inserted into the housing.

8. The optical disc cassette of claim 7, wherein the multi-section anti-rotation element further comprises at least a first portion and at least a second portion such that the first portion adapts to be against the edge of the first optical disc and the second portion adapts to be against the edge of the second optical disc.

9. The optical disc cassette of claim 8, wherein the first portion and the second portion are connected with each other or are detached from each other.

10. The optical disc cassette of claim 7, wherein each carrier surface comprises a first optical disc carrier region and a second optical disc carrier region and at least part of the indentations extends from the edge of the optical disc carrier to the edge of the first optical disc carrier region.

11. The optical disc carrier of claim 10, wherein each optical disc carrier has a plurality of anti-slip structures disposed near the edge of the first optical disc carrier region and the anti-slip structures is suitable for positioning the optical disc inside the first optical disc carrier region.

12. The optical disc cassette of claim 7, further comprises a latching element disposed on an inner wall of the housing wherein the first optical disc carrier and the second optical disc carrier each has a latch-up portion for engaging with the latching element.

13. The optical disc cassette of claim 7, wherein the housing has an opening and a plurality of sets of guiding tracks disposed on the inner wall of the housing such that the guiding tracks extend in a direction towards the opening and the first optical disc carrier and the second optical disc carrier are each suitable for sliding within a set of the guiding tracks.

14. An optical disc drive, comprising:
a disc exchanger suitable for operating within an operating range;
a data processing module disposed within the operating range;
an optical disc cassette disposed within the operating range and suitable for storing a plurality of optical discs, the optical disc cassette further comprising:
a housing;
a plurality of optical disc carriers suitable of inserting inside the housing, wherein each optical disc carrier has a carrier surface and an indentation located on an edge; and
a sweeping anti-rotation element disposed in a movable way inside the housing to correspond with the indentation, wherein the sweeping anti-rotation element is suitable for moving inside the indentation to be against the edges of the optical discs when the optical disc carrier is inserted into the housing.

15. The optical disc drive of claim 14, wherein the sweeping anti-rotation element comprises a straight rod or a plurality of movable anti-rotation units inside the indentations.

16. The optical disc drive of claim 14, wherein each carrier surface comprises a first optical disc carrier region and a second optical disc carrier region and at least part of the indentations extends from the edge of the optical disc carrier to the edge of the first optical disc carrier region.

17. The optical disc drive of claim 16, wherein each optical disc carrier has a plurality of anti-slip structure disposed on the edge of the first optical disc carrier region and the anti-slip structures are suitable for positioning the optical disc inside the first optical disc carrier region.

18. The optical disc drive of claim 14, wherein the optical disc cassette further comprises a latching element disposed on an inner wall of the housing wherein each of the optical disc carriers has a latch-up portion for engaging with the latching element.

19. The optical disc drive of claim 14, wherein the housing has an opening and a plurality of sets of guiding tracks disposed on the inner wall of the housing such that the guiding tracks extend in a direction towards the opening and each of the optical disc carriers is suitable for sliding within a set of the guiding tracks.

20. The optical disc drive of claim 14, wherein the data processing module comprises an optical disc pick-up module or an optical disc read/write module.
